(19) United States
(12) Patent Application Publication
(10) Pub. No.: US 2020/0377160 A1
(43) Pub. Date: Dec. 3, 2020

(54) APPARATUS AND METHOD FOR LOADING A SPARE TIRE OF A VEHICLE

(71) Applicants: HYUNDAI MOTOR COMPANY, Seoul (KR); KIA MOTORS CORPORATION, Seoul (KR)

(72) Inventor: Jae Sung Jung, Hwaseong-si (KR)

(73) Assignees: HYUNDAI MOTOR COMPANY, Seoul (KR); KIA MOTORS CORPORATION, Seoul (KR)

(21) Appl. No.: 16/868,299

(22) Filed: May 6, 2020

(30) Foreign Application Priority Data
May 29, 2019 (KR) 10-2019-0062879

(51) Int. Cl. B62D 43/00; B60S 9/04; B62D 43/02

(52) U.S. Cl. CPC B62D 43/002; B62D 43/02; B60S 9/04

(57) ABSTRACT

An apparatus and a method for loading a spare tire of a vehicle are provided so that the spare tire does not appear on a bottom of a luggage compartment of the vehicle without interfering with a space or a structure for mounting a battery. The apparatus and the method for loading the spare tire of the vehicle includes: a jack-up device for providing a supporting force to support the spare tire positioned on an upper side thereof in a state of being stored in an accessory storage space of a vehicle body panel; and a support assembly installed in the accessory storage space of the vehicle body panel to support the spare tire loaded thereon.

### CROSS REFERENCE TO RELATED APPLICATION

The present application claims priority to Korean Patent Application No. 10-2019-0062879, filed May 29, 2019, the entire contents of which are incorporated herein for all purposes by this reference.

### BACKGROUND OF THE DISCLOSURE

### Field of the Disclosure

The present disclosure relates to an apparatus and a method for loading a spare tire of a vehicle and, more particularly, to an apparatus and a method for loading the spare tire to store and fasten the spare tire in the vehicle.

### Description of the Related Art

In general, a spare tire is an auxiliary tire that is stored in a vehicle so that a damaged tire may be replaced with the spare tire in case of emergency such as a tire puncture. The spare tire is usually stored in a tire well which is provided at the bottom of a luggage compartment of the vehicle.

The tire well is provided in a recessed shape to store the spare tire on a vehicle body panel, i.e., a rear floor panel, which provides a bottom of the luggage compartment. When storing the spare tire, the spare tire is stored in a state of being fastened to the tire well so as not to be shaken or make noise generated from the spare tire being shaken during driving the vehicle.

After the spare tire is stored in the tire well, the spare tire is covered by putting a luggage board thereon. The luggage board is a member that covers the spare tire to hide the storage state thereof and is an interior material providing a bottom of the luggage compartment.

In addition, in the event of replacing the damaged tire with the spare tire due to the vehicle having a flat tire, it is necessary to use a jack-up device that may lift and support the vehicle body to the desired height. Therefore, the jack-up device is often provided together with the spare tire as one set when buying a vehicle.

When the tire is continually carried in a usual way in the luggage compartment during driving the vehicle, there is a problem of lowering fuel efficiency because the spare tire weighs no less than 15 to 20 kg.

Accordingly, in recent years, car manufacturers have eliminated existing spare tires for weight reduction and fuel efficiency of the car, and instead provide a small and light tire repair kit (tire mobility kit, or “TMK”).

When a small tire repair kit is provided instead, there is an advantage of not having to prepare a tire well on the rear floor panel having ample enough storage for a spare tire and which is a part of the vehicle body inside the luggage compartment. Furthermore, there is an additional advantage of weight reduction and fuel efficiency of the vehicle.

In particular, in the case of an electric vehicle which is gradually increasing in production and sales in recent years, due to a space needed for mounting a large capacity battery, it is difficult to prepare a tire well, which is a tire storage space, on the rear floor panel at the bottom of the luggage compartment.

In more detail, in a typical electric vehicle, a battery is mainly mounted and loaded on a lower side of a vehicle body, and in this case, a part of the battery is mounted to be positioned below the rear floor panel.

Since the battery for a large-capacity electric vehicle has heavy weight and bulky volume, sufficient mounting rigidity should be secured. To this end, after providing a mounting unit having a shape capable of securing rigidity on the rear floor panel, a bracket is attached to this mounting unit. Then the battery is supported by the mounting unit via the bracket.

However, when a mounting unit having a shape protruding downward from the rear floor panel is provided, interference between the tire storage space and the mounting unit occurs on the rear floor panel. Consequently, the mounting unit causes the tire well unable to secure a sufficient size of space to store the spare tire.

As such, due to the space for mounting a battery in electric vehicles, it is unable to load the spare tire by providing the tire well on the bottom of the luggage compartment as in the conventional internal combustion engine vehicle. Thus, a compact and portable tire repair kit (TMK) is offered in place of the spare tire.

In countries where carrying the spare tire is mandated by law, the spare tire should also be loaded on an electric vehicle. In this case, car manufacturers provide a spare tire which may simply be carried on the luggage board in the luggage compartment of the electric vehicle.

However, there is a problem that the storage state of the spare tire in the luggage compartment is exposed. There is also a space limitation in use of the luggage compartment due to the spare tire being placed on the luggage board.

However, when car manufacturers try to store the spare tire inside the tire well at the bottom of the luggage compartment in the vehicle body part so as not to expose the storage state of the spare tire, there is no alternative but to change the shape and structure of the vehicle body such as a battery mounting space, a battery mounting position, a battery mounting structure, and the rear floor panel.

As a result, even in the same car model, due to laws and regulations, there is a problem in that the vehicle body should be redesigned and manufactured differently without the vehicle body being used in common with other countries.

### SUMMARY OF THE DISCLOSURE

Accordingly, the present disclosure has been created to solve the above problems. The objective of the present disclosure is to provide an apparatus and a method for loading a spare tire of a vehicle so that the spare tire does not appear on a bottom of a luggage compartment of the vehicle without interfering with a space or a structure for mounting a battery.

In addition, another objective of the present disclosure is to provide an apparatus and a method for loading a spare tire which may store the spare tire without changing an existing vehicle body so as not to be exposed in appearance and continue to share the vehicle body in common use regardless of spare tire-related laws and regulations.

In order to achieve the above objective, according to one aspect of the present disclosure, there is provided an apparatus for loading a spare tire of a vehicle. The apparatus includes: a jack-up device for providing a supporting force to support the spare tire positioned on an upper side of the jack-up device in a state of being stored in an accessory storage space of a vehicle body panel; and a support assembly installed in the accessory storage space of the vehicle body panel to support the spare tire loaded on the support assembly.

The jack-up device may be a jack-up device for lifting a vehicle body provided together with the spare tire to be used when mounting the spare tire.

In addition, the vehicle body panel may be a rear floor panel positioned behind rear seats. The accessory storage space may be a storage space which is provided in a shape recessed downward from the rear floor panel.

In addition, the apparatus for loading a spare tire of a vehicle may further include a jack-fixing mount fixedly installed on an inner surface of the accessory storage space of the vehicle body panel. The jack-fixing mount may be configured to fix the jack-up device in the accessory storage space when the jack-up device is in a coupled state.

The spare tire, when loaded, may be supported by the jack-fixing mount. The jack-up device may be arranged under the jack-fixing mount so that the spare tire is supported by the jack-fixing mount when an upper bracket of the jack-up device is raised to be in contact with and coupled to a bottom surface of the jack-fixing mount.

In addition, the support assembly may include: a plurality of rods installed side by side so as to cross an upper side of the accessory storage space of the vehicle body panel; a fastening bracket installed to connect the plurality of rods to each other; and a fastening member for fastening the spare tire to the fastening bracket.

As another aspect of the present disclosure, there is provided a method for loading a spare tire of a vehicle. The method includes: placing a jack-up device in an accessory storage space of a vehicle body panel; positioning the spare tire over the jack-up device such that a supporting force provided by the jack-up device is applied to the spare tire; and fastening and fixing the spare tire to a support assembly in a state in which the spare tire is mounted on and supported by the support assembly installed in the accessory storage space of the vehicle body panel.

The jack-up device may be a jack-up device for lifting a vehicle body. The jack-up device may be provided together with the spare tire to be used when mounting the spare tire.

In addition, the vehicle body panel may be a rear floor panel positioned behind rear seats. The accessory storage space may be a storage space which is provided in a shape recessed downward from the rear floor panel.

In addition, the jack-up device may be arranged under a jack-fixing mount fixedly installed on an inner surface of the accessory storage space of the vehicle body panel. The jack-up device may be fixed by the jack-fixing mount in the accessory storage space, and at the same time, the jack-fixing mount may be supported by the jack-up device by raising an upper bracket of the jack-up device to contact and couple the upper bracket to a lower surface of the jack-fixing mount.

Thus, based on an apparatus and a method for loading a spare tire of a vehicle, the spare tire in electric vehicles may be loaded on the bottom of the luggage compartment of the vehicle so that the tire is not exposed, regardless of the mounting space or mounting structure for the battery.

In addition, based on the apparatus and the method for loading the spare tire of the vehicle according to the present disclosure, the spare tire may be stored on the bottom of the luggage compartment of the vehicle so that the spare tire is not exposed in appearance without changing the existing vehicle body. The vehicle body may continue to be used on public roads regardless of spare tire-related laws and regulations.

### BRIEF DESCRIPTION OF THE DRAWINGS

FIG. 1 is a plan view illustrating a mounted state of a spare tire according to the present disclosure.

FIG. 2 is a plan view of an installed state of a luggage board in which the spare tire is mounted according to the present disclosure.

FIG. 3 is a plan view illustrating a loading apparatus for a spare tire according to an embodiment of the present disclosure.

FIG. 4 is a cross-sectional view of a state of a spare tire loaded by the loading apparatus according to an embodiment of the present disclosure.

FIG. 5 is a cross-sectional view illustrating the spare tire and the luggage board separated from the loading apparatus according to an embodiment of the present disclosure.

FIG. 6 is a perspective view illustrating a coupling state of a jack-up device and a jack-fixing mount in the loading apparatus according to an embodiment of the present disclosure.

FIG. 7 is a perspective view illustrating the jack-up device separated from the jack-fixing mount in the loading apparatus according to an embodiment of the present disclosure.

### DETAILED DESCRIPTION OF THE DISCLOSURE

Hereinafter, an embodiment of the present disclosure is described in detail with reference to the accompanying drawings so that those having ordinary skill in the art may easily implement the present disclosure. However, the present disclosure is not limited to the embodiments described herein and may be embodied in other forms.

When throughout the specification, any part is recited as “including” or “comprising” any component, this means that the part may further include or comprise other components rather than excluding them, unless otherwise stated.

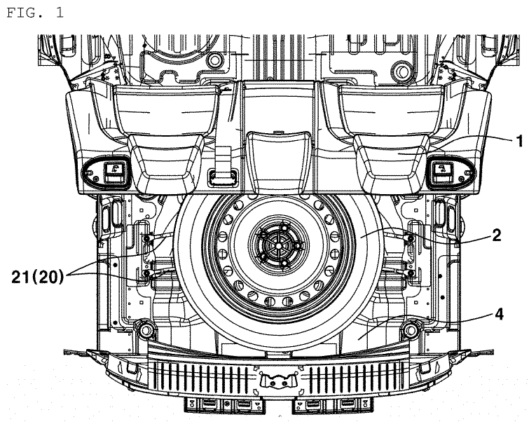

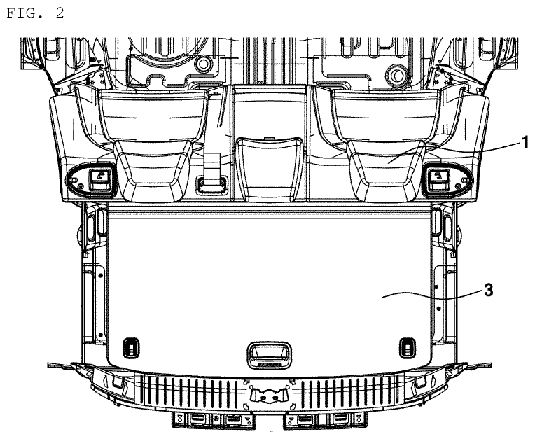

FIG. 1 is a plan view illustrating a mounted state of a spare tire according to the present disclosure and illustrates a state in which a luggage board is omitted. FIG. 2 is a plan view illustrating a state in which the luggage board is installed with the spare tire being mounted according to the present disclosure.

As shown, the spare tire 2 is mounted on a bottom surface of the vehicle space provided at the back of a seat 1. The luggage board 3 is installed on the upper side of the spare tire 2 with the spare tire 2 loaded thereon.

In FIG. 1, the seat 1 may be a rear seat. The vehicle space in which the spare tire 2 is loaded may be a luggage compartment of the vehicle. The spare tire is loaded on a rear floor panel 4 providing a bottom of the luggage compartment.

The present disclosure relates to a loading apparatus provided for loading the spare tire 2 on the rear floor panel 4 providing the bottom of the luggage compartment. After the spare tire 2 is loaded on the rear floor panel 4 in the luggage compartment by means of the loading device according to the present disclosure, the luggage board 3 is installed so as to cover the upper side thereof.

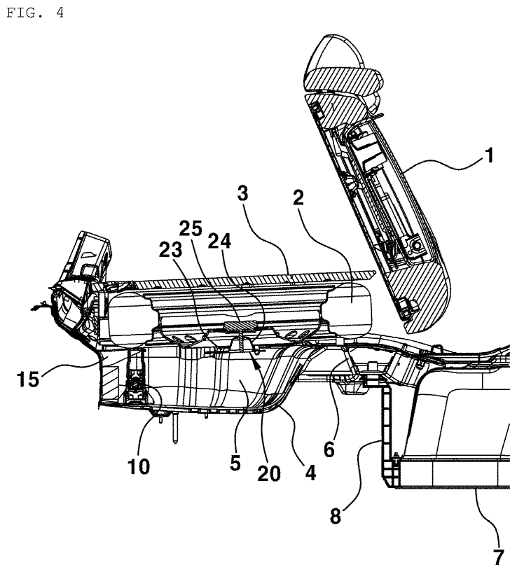

The luggage board 3 is coupled to the rear floor panel 4 so as to be positioned horizontally on the spare tire 2 (see FIG. 4). As a result, the luggage board 3 covering the spare tire 2 provides the bottom of the luggage compartment as shown in FIG. 2.

In this way, the luggage board 3 becomes a member that covers up the spare tire 2 so as not to be exposed and visible in the luggage compartment. The luggage board 3 also becomes an interior material providing the bottom of the luggage compartment.

As described above, the loading apparatus and the loading method according to the present disclosure may be effectively applied to an electric vehicle in which a battery mounting space should be secured under the vehicle body, more specifically, the electric vehicle in which a battery occupies the lower space of the rear seat and rear floor panel as the battery mounting space.

In particular, the loading apparatus and the loading method according to the present disclosure may be applied to the electric vehicle having only a small accessory storage space on the rear floor panel in the luggage compartment behind the rear seat. Thus, the main focus is to allow the spare tire to be loaded without changing the vehicle body parts such as rear floor panels.

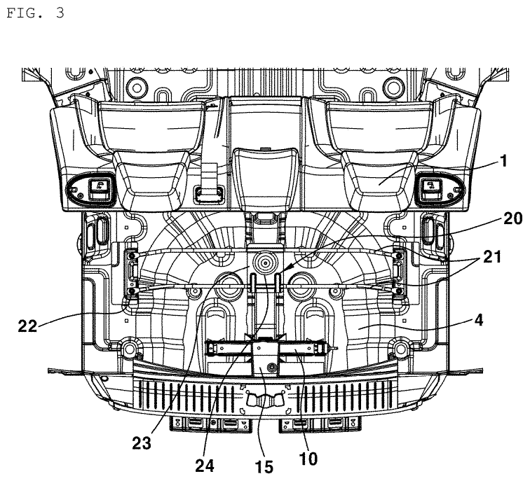

FIG. 3 is a plan view illustrating the apparatus for loading the spare tire according to an embodiment of the present disclosure, showing a state before the tire is loaded.

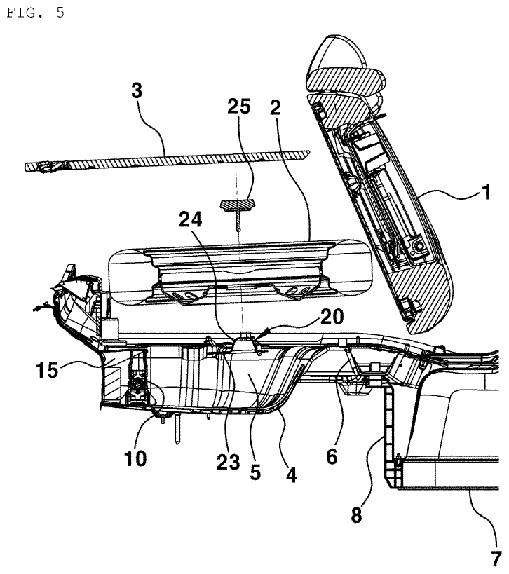

FIG. 4 is a cross-sectional view of a state in which the spare tire is loaded by the loading apparatus according to an embodiment of the present disclosure. FIG. 5 is a cross-sectional view illustrating the spare tire and the luggage board separated from the loading apparatus according to the embodiment of the present disclosure.

As shown, on the rear floor panel 4 of the electric vehicle to which the present disclosure is applied, the accessory storage space 5 may be provided behind the rear seat 1 and the lower battery mounting space thereof.

In FIG. 4, reference numeral 6 denotes a mounting unit provided in a ‘C’ shape so as to secure rigidity in the rear floor panel 4. The battery side bracket 8 is fastened to the mounting unit 6 to support the battery 7 by the mounting unit 6 via the bracket 8.

Although the accessory storage space 5 is not able to store the spare tire in the vehicle, as shown in FIGS. 4 and 5, it is a storage space of a small size provided in the shape recessed downward from the rear floor panel 4 in order to accommodate small-sized articles, for example, various tools such as a screwdriver.

The accessory storage space 5 is the storage space that is provided in a conventional vehicle, for example, the known electric vehicle, and this space may be used to store a Tire Mobility Kit (TMK) in the vehicle with which the spare tire is not provided.

As such, when a vehicle, which is provided with the tire repair kit in place of a spare tire in certain countries, is going to be used in other countries where a vehicle is required to be equipped with a spare tire subject to the laws and regulations thereof, the loading apparatus according to the present disclosure allows the spare tire to be loaded onto the rear floor panel without exposing the spare tire by using the existing accessory storage space 5 which may not store as big an article as the entire spare tire unless the existing vehicle body is modified.

To this end, the apparatus for loading the spare tire according to an embodiment of the present disclosure is installed and configured in the space behind the rear seat 1, in particular on the rear floor panel 4. The apparatus includes a jack-up device, which is installed inside the storage space 5 of the rear floor panel 4 to provide a supporting force for supporting the spare tire 2, and a support assembly 20 installed to be positioned on the upper side of the storage space 5 of the rear floor panel 4 and on which the spare tire 2 is loaded.

In addition, the apparatus may further include a jack-fixing mount 15 fixedly installed on one side of the rear floor panel 4, more specifically, on the inner surface of the rear side of the rear floor panel 4 in the storage space 5 of the rear floor panel 4.

The jack-fixing mount 15 is coupled to the jack-up device 10 in a state of being installed on the inner surface of the rear side of the rear floor panel 4 and is provided with a supporting force provided by the jack-up device. The jack-fixing mount 15 becomes a supporting structure that supports the spare tire 2 which is loaded upward in the storage space 5 of the rear floor panel 4, together with the support assembly 20.

Since the jack-fixing mount 15 is fixedly installed on the rear floor panel 4, the jack-fixing mount 15 may itself be the supporting structure for supporting the spare tire 2. However, if the jack-up device 10 does not support the jack-fixing mount 15 at the lower side of the jack-fixing mount 15, the jack-fixing mount 15 alone is insufficient in terms of rigidity in supporting the spare tire 2.

Therefore, in the present disclosure, the jack-fixing mount 15 is supported by the jack-up device 10 when the spare tire 2 is loaded, thereby securing the stable supporting rigidity and the supporting force.

In addition, the jack-fixing mount 15 serves as a fixing structure for fixing the jack-up device 10 so as not to move in the storage space 5 in a state being coupled to the jack-up device 10.

As described above, in the present disclosure, the jack-up device 10 normally provided with the spare tire 2 is utilized as a component part of the apparatus for loading the spare tire on the rear floor panel 4.

The jack-up device 10 supports the jack-fixing mount 15 from the lower side when the spare tire 2 is loaded on the jack-fixing mount 15, thereby not only serving to support the spare tire 2 via the jack-fixing mount 15 but also preventing the jack-fixing mount 15 from bending or deforming downward.

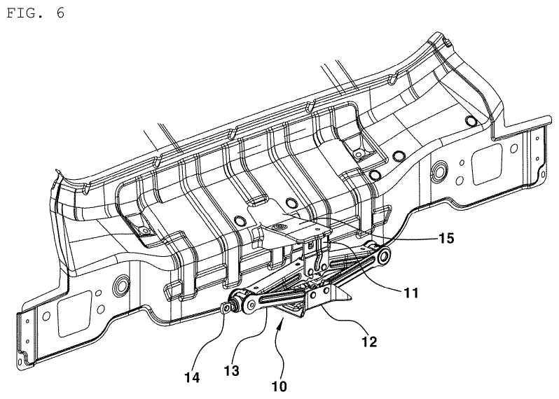

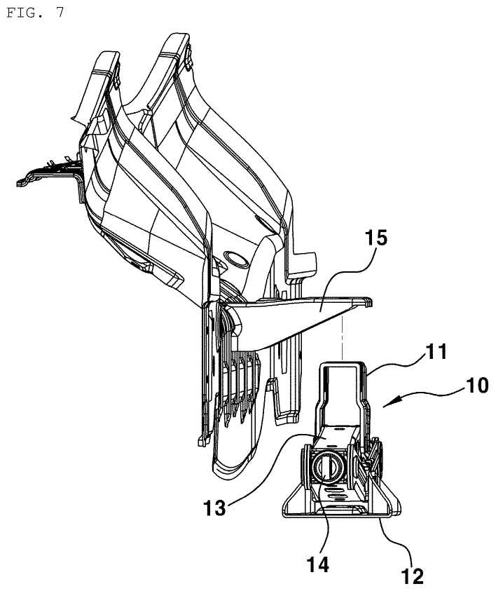

Referring to the drawings in more detail, FIG. 6 is a perspective view illustrating a coupling state of the jack-up device 10 and the jack-fixing mount 15 in the loading apparatus according to an embodiment of the present disclosure. FIG. 7 is a perspective view illustrating the jack-up device 10 separated from the jack-fixing mount 15 in the loading apparatus according to an embodiment of the present disclosure.

As shown in FIGS. 4-7, the jack-fixing mount 15 is mounted on the inner surface of the rear side of the rear floor panel 4 so as to be positioned in the storage space 5 of the rear floor panel 4, which is fixedly installed in the way such as welding or the like.

Then, after the jack-up device 10 is positioned below the jack-fixing mount 15 in the storage space 5 of the rear floor panel 4, an upper bracket 11 of the jack-up device 10 is raised to allow the upper bracket 11 to be coupled to the jack-fixing mount 15.

The jack-up device 10 includes the upper bracket 11, a lower bracket 12, a link member 13 between the upper bracket 11 and the lower bracket 12, and a handle portion 14. The jack-up device 10 may move the upper bracket 11 up and down by operating the link member 13 through the handle portion 14.

This jack-up device 10 is a known mechanism provided with the spare tire 2, and thus the configuration of the jack-up device 10 in the present disclosure is not different from the known jack-up device, and thus detailed description thereof is omitted.

With this, after positioning the jack-up device 10 in the storage space 5 of the rear floor panel 4 under the jack-fixing mount 15, the upper bracket 11 is brought into contact with and coupled to the lower surface of the jack-fixing mount 15 by operating the link member 13 through the handle portion 14 of the jack-up device 10 to raise the upper bracket 11.

Accordingly, the jack-up device 10 may be fixed so as not to move around in the storage space 5 of the rear floor panel 4. Further, the force acting upward through the upper bracket 11 acts as a force supporting the jack-fixing mount 15 from the lower side and at the same time serves as the supporting force for stably supporting the spare tire 2.

Of course, in the process of replacing the tire of the vehicle with the spare tire 2 in case of emergency, the jack-up device 10 is used to lift and support the vehicle body to a desired height by separating it from the storage space 5 of the rear floor panel 4. This mechanism is the same as using the existing jack-up device.

After lifting the spare tire 2 which was in a state of being loaded during the replacement process, the upper bracket 11 is lowered to separate it from the jack-fixing mount 15. Thereafter, the separated jack-up device 10 is removed from the storage space 5 of the rear floor panel 4 and then used to lift the vehicle body.

One side of the spare tire 2 (the left part of the tire in FIG. 4) is lifted up and supported on the jack-fixing mount 15. The other side part (the right part of the tire in FIG. 4) of the spare tire 2 is loaded on the upper surface of the front part of the rear floor panel 4 and supported.

Then, the spare tire 2 is supported on the support assembly 20. The support assembly 20 is installed so as to be in an arrangement form crossing over the storage space 5 of the rear floor panel 4.

As shown in FIG. 1, the support assembly 20 is positioned so as to be able to support roughly the center portion of the spare tire 2 from underneath.

In the embodiment of the present disclosure, the support assembly 20, as illustrated in FIG. 3, may be configured to include: a plurality of rods 21 installed in a row so as to cross the upper side of the storage space 5 of the rear floor panel 4 from side to side; a fastening bracket 23 installed to connect the middle portion of the plurality of rods 21 with each other; and a fastening member 25 for fastening the spare tire 2 to the fastening bracket 23.

In this configuration, both ends of the plurality of rods 21 may be fixed to both upper surfaces of the left and right sides of the rear floor panel 4 by fixing members 22 such as bolts.

In addition, the fastening bracket 23 is provided with a fastening portion 24 protruding upward. The spare tire 2 and the fastening bracket 23 are fixed by the fastening member 25 tightened to pass through the fastening part 24 and the rim of the spare tire 2.

By this, the spare tire 2 is supported by the support assembly 20, and at the same time, is fixed so that it may not be moved.

In this way, in the present disclosure, after the jack-up device for lifting the vehicle body provided with the spare tire is positioned in the accessory storage space of the rear floor panel, the spare tire may be loaded under the luggage board in the luggage compartment without the existing tire well in which the entire spare tire may be stored. This may be done by applying a method of horizontally supporting the spare tire over the rear floor panel and the jack-up device.

In particular, according to the present disclosure, the spare tire may be loaded at the bottom of the luggage compartment so that the spare tire is not exposed in appearance and without interference with the battery mounting space or the mounting structure for mounting the battery. The spare tire may be loaded without modifying the existing vehicle body, allowing the vehicle body to be used on public roads regardless of spare tire-related laws and regulations.

Although the embodiments of the present disclosure have been described in detail above, the scope of the present disclosure is not limited thereto, and various modifications and improvements of those having ordinary skill in the art using the basic concepts of the present disclosure as defined in the following claims are also included in the scope of the present disclosure.

What is claimed is:

1. An apparatus for loading a spare tire of a vehicle, the apparatus comprising:
a jack-up device for providing a supporting force to support the spare tire positioned on an upper side of the jack-up device in a state of being stored in an accessory storage space of a vehicle body panel; and
a support assembly installed in the accessory storage space of the vehicle body panel to support the spare tire loaded on the support assembly.

2. The apparatus for loading a spare tire of a vehicle of claim 1, wherein the jack-up device is a jack-up device for lifting a vehicle body provided together with the spare tire to be used when mounting the spare tire.

3. The apparatus for loading a spare tire of a vehicle of claim 1, wherein
the vehicle body panel is a rear floor panel positioned behind rear seats, and
the accessory storage space is a storage space provided in a shape recessed downward from the rear floor panel.

4. The apparatus for loading a spare tire of a vehicle of claim 1, further comprising:
a jack-fixing mount fixedly installed on an inner surface of the accessory storage space of the vehicle body panel, the jack-fixing mount configured to fix the jack-up device in the accessory storage space when the jack-up device is in a coupled state.

5. The apparatus for loading a spare tire of a vehicle of claim 4, wherein
the spare tire, when loaded, is supported by the jack-fixing mount, and
the jack-up device is arranged under the jack-fixing mount so that the spare tire is supported by the jack-fixing mount when an upper bracket of the jack-up device is raised to be in contact with and coupled to a bottom surface of the jack-fixing mount.

6. The apparatus for loading a spare tire of a vehicle of claim 1, wherein the support assembly comprises:
a plurality of rods installed side by side so as to cross over the accessory storage space of the vehicle body panel;
a fastening bracket installed to connect the plurality of rods to each other; and
a fastening member for fastening the spare tire to the fastening bracket.

7. A method for loading a spare tire of a vehicle, the method comprising:
placing a jack-up device in an accessory storage space of a vehicle body panel;
positioning the spare tire on an upper side of the jack-up device such that a supporting force provided by the jack-up device is applied to the spare tire; and
fastening and fixing the spare tire to a support assembly in a state in which the spare tire is mounted on and supported by the support assembly installed in the accessory storage space of the vehicle body panel.

8. The method for loading a spare tire of a vehicle of claim 7, wherein the jack-up device is a jack-up device for lifting a vehicle body, the jack-up device being provided together with the spare tire to be used when mounting the spare tire.

9. The method for loading a spare tire of a vehicle of claim 7, wherein
the vehicle body panel is a rear floor panel positioned behind rear seats, and
the accessory storage space is a storage space provided in a shape recessed downward from the rear floor panel.

10. The method for loading a spare tire of a vehicle of claim 7, wherein
the jack-up device is arranged under a jack-fixing mount fixedly installed on an inner surface of the accessory storage space of the vehicle body panel, and
the jack-up device is fixed by the jack-fixing mount in the accessory storage space, and at the same time, the jack-fixing mount is supported by the jack-up device by raising an upper bracket of the jack-up device to contact and couple the upper bracket to a lower surface of the jack-fixing mount.
